(19) United States
(12) Patent Application Publication
(10) Pub. No.: US 2026/0332597 A1
(43) Pub. Date: Oct. 22, 2026

(54) METHOD AND SYSTEM FOR IDENTITY AND ACCESS MANAGEMENT

(71) Applicant: Wistron Corp., New Taipei City (TW)

(72) Inventors: Hao Qing OU, New Taipei City (TW); Chunlun KUO, New Taipei City (TW); Tzu Wei HUNG, New Taipei City (TW)

(21) Appl. No.: 19/256,392

(22) Filed: Jul. 1, 2025

(30) Foreign Application Priority Data
Apr. 18, 2025 (TW) 114114691

(51) Int. Cl. H04L 9/40

(52) U.S. Cl. CPC H04L 63/102; H04L 63/123

(57) ABSTRACT

A method for identity and access management is provided. The method includes receiving IAM policy information by an identity and access management (IAM) policy center, wherein the IAM policy information includes user account information, services that a user is allowed to access, and application programming interfaces that the user is allowed to access. The method includes receiving, by an IAM policy agent, the IAM policy information transmitted by the IAM policy center. The method includes verifying, by the IAM policy agent, whether a token is valid based on the IAM policy information when receiving a request message including the token corresponding to a first user transmitted by a front-end browser. The method includes allowing, by the IAM policy agent, the first user to access a first service that the first user is allowed to access when the token is valid.

### CROSS REFERENCE TO RELATED APPLICATIONS

This Application claims priority of Taiwan Patent Application No. 114114691, filed on Apr. 18, 2025, the entirety of which is incorporated by reference herein.

### TECHNICAL FIELD

The present disclosure generally relates to the field of network technologies. More specifically, aspects of the present disclosure relate to a method and a system for identity and access management (IAM).

### BACKGROUND

With the rapid evolution of information technologies, enterprises are constantly introducing new services and applications in the process of digital transformation and gradually adopting microservices architecture to replace traditional monolithic systems. Although this development has improved the flexibility and scalability of the system, it has also brought the following challenges.

Increased complexity of authentication management:

Under the microservice architecture, each microservice developer needs to develop their own microservices and maintain their own authentication and authorization mechanisms, resulting in inconsistent authentication standards for each microservice, increasing development and maintenance costs and exposing system security to potential risks.

Identity verification integration between multiple systems is difficult:

When an enterprise uses multiple systems, the respective authentication systems are difficult to integrate with each other, resulting in users having to log in multiple times or perform repeated authentication, which reduces the user experience.

Compatibility requirements with external identity providers:

Enterprises need to integrate with different identity providers and IAM systems (such as Azure AD, Okta, Google Identity, etc.). However, the lack of a unified architecture for managing identities and permissions will reduce the overall system's operational efficiency and affect the system's scalability.

Compliance requirements and information security assurance:

As national laws and regulations (such as GDPR and ISO 27001) continue to increase their requirements for data protection and identity management, companies need to ensure that their system's authentication architecture meets the latest security standards to avoid potential legal risks.

Therefore, there is a need for a method and system for identity and access management to achieve unified identity verification and access management for various system services. On the one hand, it can not only improve the interoperability between systems, but also effectively reduce development and maintenance costs and meet the needs of a multi-platform, multi-interface environment within an enterprise.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method and system for identity and access management. The system disclosed herein uses an IAM policy center to centrally manage users, user roles and permissions, allowing managers to quickly adjust and audit user permissions. In addition, the system disclosed herein uses an IAM policy agent to be deployed in front of each service in a sidecar mode to ensure that the latest IAM policy information can be obtained. Since all verification and authorization are handled uniformly by the IAM policy agent, the service only needs to be responsible for business logic, which can greatly reduce development and maintenance costs and improve system integration and security.

In an exemplary embodiment, a method for identity and access management is provided. The method includes receiving IAM policy information by an identity and access management (IAM) policy center, wherein the IAM policy information includes user account information, services that a user is allowed to access, and application programming interfaces that the user is allowed to access. The method includes receiving, by an IAM policy agent, the IAM policy information transmitted by the IAM policy center. The method includes verifying, by the IAM policy agent, whether a token is valid based on the IAM policy information when receiving a request message including the token corresponding to a first user transmitted by a front-end browser. The method includes allowing, by the IAM policy agent, the first user to access a first service that the first user is allowed to access when the token is valid.

In some embodiments, the method further comprises denying, by the IAM policy agent, the first user access to the first service that the first user is allowed to access when the token is invalid.

In some embodiments, after the IAM policy center receives the IAM policy information, the method further comprises transmitting, by the IAM policy center, the IAM policy information to an identity provider. The method further comprises receiving, by the identity provider, first account information of the first user input by the first user through the front-end browser. The method further comprises generating, by the identity provider, the token according to the IAM policy information and the first account information of the first user. The method further comprises transmitting, by the identity provider, the token to the front-end browser so that the front-end browser generates the request message.

In some embodiments, the first service is in a service mash.

In some embodiments, the IAM policy agent is in the service mash.

In some embodiments, the request message is transmitted to the IAM policy agent through an application programming interface management (APIM).

In some embodiments, when the token is valid, the IAM policy agent allows the first user to access the first service that the first user is allowed to access through the APIM.

In some embodiments, after the IAM policy agent receives the IAM policy information, the IAM policy agent stores the IAM policy information in a cache.

In some embodiments, the token is in a JWT format.

In some embodiments, when the token is invalid, the IAM policy agent returns an HTTP status code 401 or an HTTP status code 403 to the front-end browser.

In an exemplary embodiment, a system for identity and access management is provided. The system comprises a first electronic device and a second electronic device. The first electronic device is configured to implement an identity and access management (IAM) policy center. The IAM policy center receives IAM policy information, wherein the IAM policy information includes user account information, services that a user is allowed to access, and application programming interfaces that the user is allowed to access. The second electronic device is configured to implement an IAM policy agent. The IAM policy agent receives the IAM policy information transmitted by the IAM policy center. The IAM policy agent verifies whether a token is valid based on the IAM policy information when receiving a request message including the token corresponding to a first user transmitted by a front-end browser. The IAM policy agent allows the first user to access a first service that the first user is allowed to access when the token is valid.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIGS. 1A to 1C are schematic diagrams of a system for identity and access management according to an embodiment of the present disclosure.

FIG. 2 is a flow chart showing a method for identity and access management according to an embodiment of the present disclosure.

FIG. 3A shows program codes for enabling the IAM policy agent according to an embodiment of the present disclosure.

FIG. 3B shows the program codes for setting up the IAM policy agent according to an embodiment of the present disclosure.

FIG. 4 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

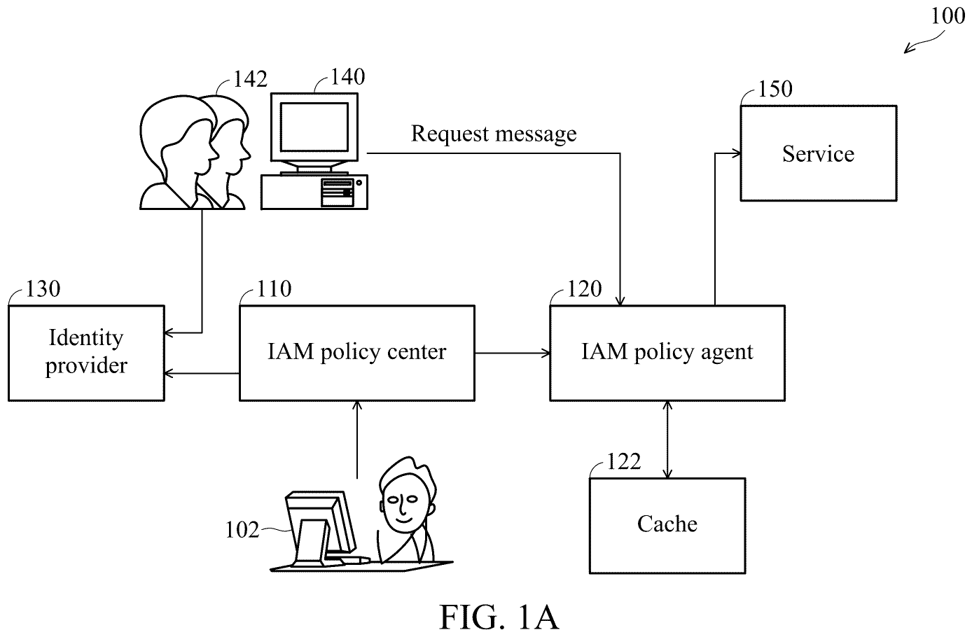

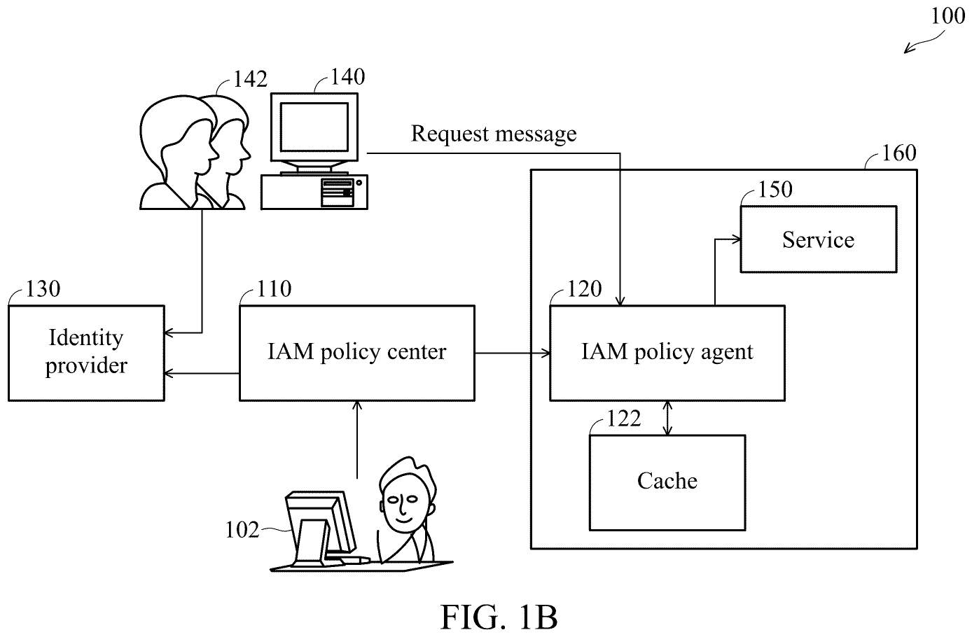

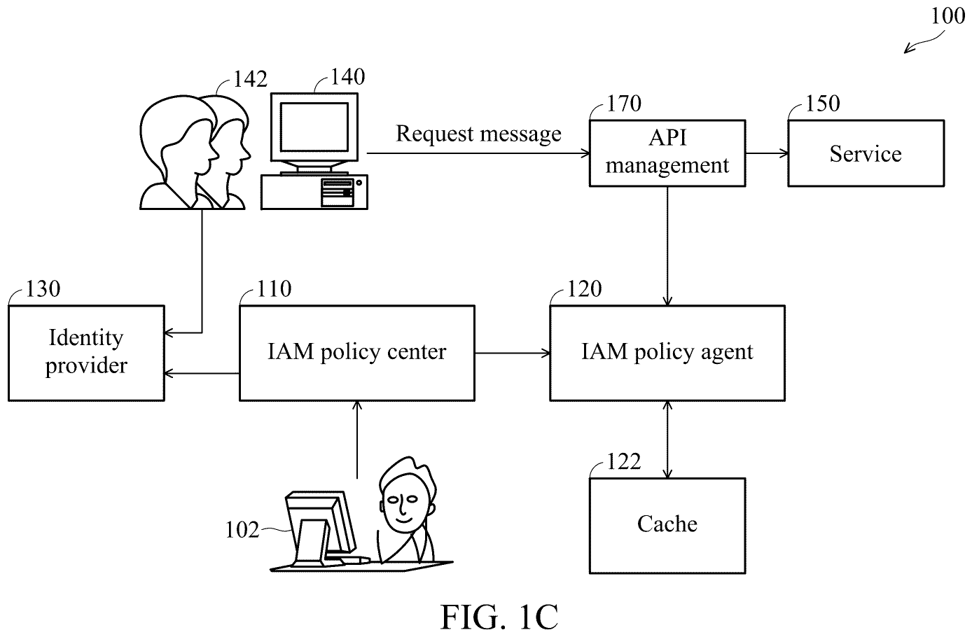

FIGS. 1A to 1C are schematic diagrams of a system 100 for identity and access management according to an embodiment of the present disclosure.

As shown in FIG. 1A, the system 100 may include at least an identity and access management (IAM) policy center 110, an identity and access management (IAM) policy agent 120, and an identity provider 130, wherein the IAM policy center 110 is connected to the IAM policy agent 120 and the identity provider 130 via a network (not shown in FIG. 1A~1C). The network is the medium used to provide communication links between the IAM policy center 110, the IAM policy agent 120, and the identity provider 130. The network may include various connection types, such as wired, wireless communication links or optical fiber cables, etc.

The IAM policy center 110, the IAM policy agent 120, and the identity provider 130 may be hardware or software. When the IAM policy center 110, the IAM policy agent 120, and the identity provider 130 are hardware, the IAM policy center 110, the IAM policy agent 120, and the identity provider 130 may be various electronic devices with a display screen, including but not limited to smart phones, tablet computers, laptops, portable notebook computers, and desktop computers. When the IAM policy center 110, the IAM policy agent 120, and the identity provider 130 are software, the IAM policy center 110, the IAM policy agent 120, and the identity provider 130 may be installed in the electronic devices listed above, and may be implemented as multiple software or software modules, or as a single software or software module, which is not specifically limited in the present disclosure.

An administrator 102 may set IAM policy information through a user interface (UI) provided by the IAM policy center 110, wherein the IAM policy information at least includes user account information, services that the user is allowed to access, and application programming interfaces (APIs) that the user is allowed to access. In another embodiment, the IAM policy information may further include role-based access control (RBAC) and attribute-based access control (ABAC).

When the IAM policy information is updated, the IAM policy center 110 transmits the IAM policy information to the IAM policy agent 120 and the identity provider 130 so that the IAM policy agent 120 and the identity provider 130 may use the latest IAM policy information at any time.

The IAM policy agent 120 receives the IAM policy information transmitted by the IAM policy center 110 and stores the IAM policy information in a cache 122. When the IAM policy agent 120 is disconnected from the IAM policy center 110, the IAM policy agent 120 may use the IAM policy information stored in the cache 122 to achieve a decentralized effect. In another embodiment, the IAM policy agent 120 may be an open policy agent (OPA) or an open policy administration layer (OPAL). It should be noted that although the IAM policy agent 120 used in this example is an open policy agent or an open policy administration layer in the present disclosure, those skilled in the art can make appropriate replacements or adjustments based on the present disclosure.

When the IAM policy agent 120 receives a request message including a token corresponding to a first user 142 input by the first user 142 through a front-end browser 140, the IAM policy agent 120 may verify whether the token is valid based on the IAM policy information.

When the token is valid, the IAM policy agent 120 allows the first user 142 to access the first service that the first user 142 is allowed to access in the back-end service 150. When the token is invalid, the IAM policy agent 120 denies the first user 142 access to the first service that the first user 142 is allowed to access.

Specifically, when the first user 142 inputs the first account information of the first user 142 through the front-end browser 140, the front-end browser 140 transmits the first account information of the first user 142 to the identity provider 130. When receiving the first account information of the first user 142, the identity provider 130 generates a token corresponding to the first user 142 according to the IAM policy information and the first account information of the first user 142, and transmits the token corresponding to the first user 142 to the front-end browser 140, so that the front-end browser 142 may generate a request message.

In another embodiment, the identity provider 130 may support IAM protocols such as OAuth 2.0 and OpenID Connect. In another embodiment, the token may be in a JWT format in accordance with an example implementation of an OpenID Connect protocol. A JWT may comprise JSON attributes, for example, of the actual authentication of the user. For example, the token may comprise the following data that may be encoded as a JWT:
aud—This may refer to the intended audience of the ID token. For example, “aud” may be the OAuth client ID of the RP;
iss—This may refer to a unique identifier of the issuer of the response;
nbf—This may indicate a not before time;
exp—This may comprises an integer and/or may identify the expiration time on or after which the token may be accepted for processing. The processing of this parameter may depend on whether the current date/time is before the expiration date/time listed in the value. For example, implementers may provide for leeway, for example, to account for clock skew. The value may be a number of seconds from 1970-01-01T0:0:0 Z as measured in UTC until the desired date/time.

The IAM management policy agent 120 may verify the aud, iss, nbf or exp in the token to confirm whether the token is valid. It should be noted that although the token uses aud, iss, nbf or exp as an example, it should not be limited in the disclosure.

In FIG. 1B, the IAM system 100 mainly includes the IAM policy center 110, the IAM policy agent 120 and the identity provider 130, wherein the IAM policy center 110 is connected to the IAM policy agent 120 and the identity provider 130. The functions of the IAM policy center 110, the IAM policy agent 120 and the identity provider 130 are the same as the illustration of the embodiment described in FIG. 1A, so the details related to the functions will be omitted.

Different from FIG. 1A, the system 100 in FIG. 1B is applied to a service mesh environment. As shown in FIG. 1B, the IAM policy agent 120 and the back-end service 150 are in a service mesh 160.

In another embodiment, the service mesh 160 may be an Istio service mesh. In one embodiment, the service mesh 160 may be managed by Kubernetes. Kubernetes is an application programming interface (API) that can coordinate the resources of the service 150. The service 150 may be deployed to run on a cluster of virtual machines and Kubernetes may schedule containers to run on those virtual machines based on their available computing resources and the resource requirements of each container.

Specifically, in the environment of the service mesh 160, the IAM policy agent 120 is attached in front of the service 150 in a sidecar mode and provides the function of verifying the token. When the IAM policy agent 120 verifies that the token is valid, the user is allowed to access the back-end service 150. When the IAM policy agent 120 verifies that the token is invalid, the IAM policy agent 120 returns an HTTP status code 401 or an HTTP status code 403 to the front-end browser 140.

In FIG. 1C, the IAM system 100 mainly includes the IAM policy center 110, the IAM policy agent 120 and the identity provider 130, wherein the IAM policy center 110 is connected to the IAM policy agent 120 and the identity provider 130. The functions of the IAM policy center 110, the IAM policy agent 120 and the identity provider 130 are the same as the illustration of the embodiment described in FIG. 1A and FIG. 1B, so the details related to the functions will be omitted.

Different from FIGS. 1A and 1B, the system 100 in FIG. 1C is applied to an Application Programming Interface Management (APIM) environment. As shown in FIG. 1C, the API management 170 is in front of the back-end service 150. When the API management 170 receives the request message, the API management 170 forwards the request message to the access management policy agent 120 for verification. When the IAM policy agent 120 verifies that the token in the request message is valid, the user is allowed to access the back-end service 150 through the API management 170. When the IAM policy agent 120 verifies that the token is invalid, the IAM policy agent 120 denies the user access to the first service that the user is allowed to access.

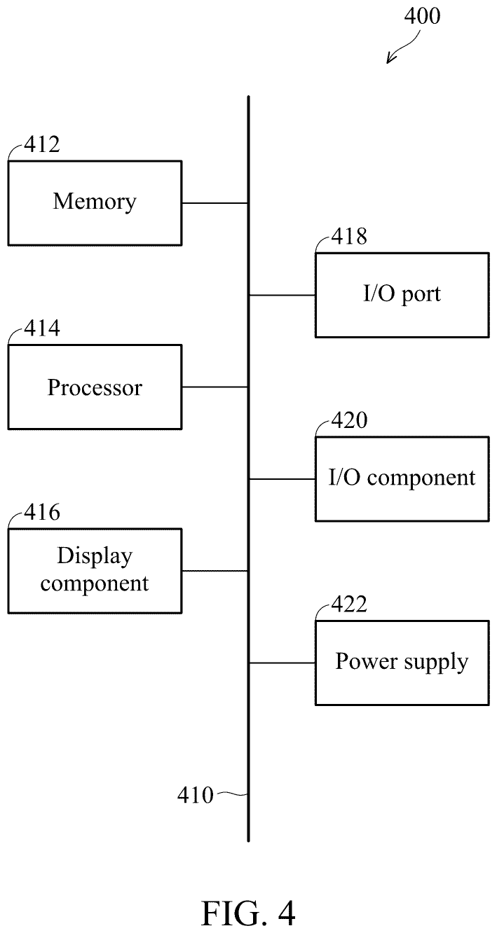

It should be understood that the IAM policy center 110, the IAM policy agent 120 and the identity provider 130 shown in FIG. 1A~1C are examples of one suitable system 100 architecture identity and access management. Each of the devices shown in FIG. 1A~1C may be implemented via any type of electronic device, such as the electronic device 400 described with reference to FIG. 4, for example.

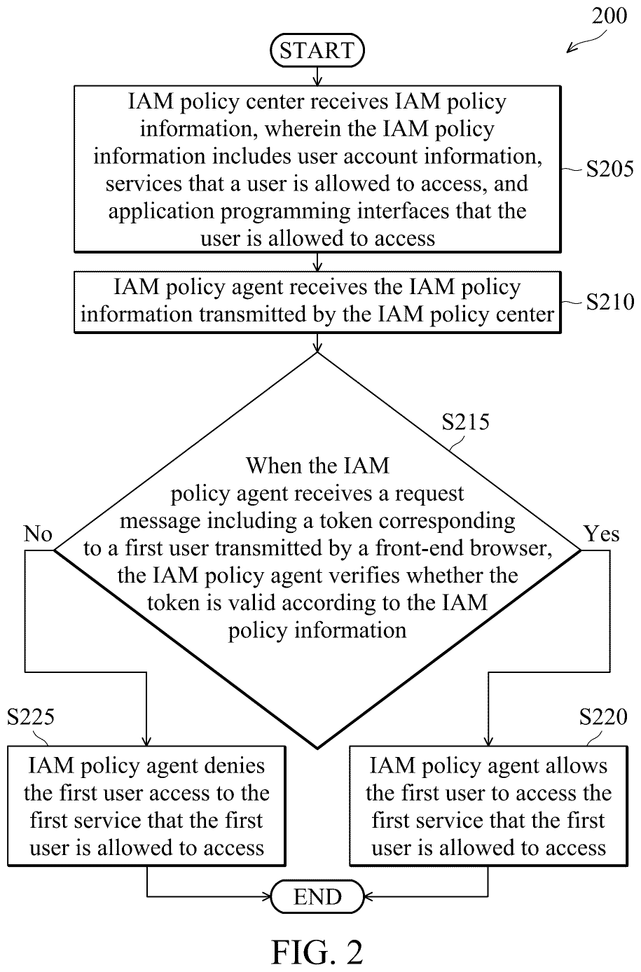

FIG. 2 is a flow chart showing a method 200 for identity and access management according to an embodiment of the present disclosure. The method may be implemented by the IAM policy center 110, the IAM policy agent 120 and the identity provider 130 in the IAM system 100 shown in FIGS. 1A-1C.

In step S205, the identity and access management (IAM) policy center receives IAM policy information, wherein the IAM policy information includes user account information, services that a user is allowed to access, and application programming interfaces that the user is allowed to access.

In step S210, the IAM policy agent receives the IAM policy information transmitted by the IAM policy center.

In step S215, when the IAM policy agent receives a request message including a token corresponding to a first user transmitted by a front-end browser, the IAM policy agent verifies whether the token is valid according to the IAM policy information.

When the token is valid (“Yes” in step S215), in step S220, the IAM policy agent allows the first user to access the first service that the first user is allowed to access.

When the token is invalid (“No” in step S215), in step S225, the IAM policy agent denies the first user access to the first service that the first user is allowed to access. In one embodiment, the IAM policy agent returns an HTTP status code 401 or an HTTP status code 403 to the front-end browser.

In one embodiment, after step S205, the IAM policy center may transmit the IAM policy information to an identity provider. The identity provider may receive the first account information of the first user input by the first user through the front-end browser, generate the token according to the IAM policy information and the first account information of the first user, and transmit the token to the front-end browser so that the front-end browser may generate a request message.

The method and system for identity and access management provided in the disclosure may ensure that service access meets security standards, allowing services to be accessed interactively under the same identity and access management architecture without having to worry about system security issues or build a complete identity and access management mechanism, thereby significantly reducing development costs.

In addition, the IAM policy agent proposed in the present disclosure allows developers to use the same process to deploy their own systems for identity and access management. Developers only need to register with the IAM policy center and obtain a sub-scription key to activate the IAM policy agent. Developers may obtain permissions of their respective projects from the IAM policy center to run the system for identity and access management without spending time developing code.

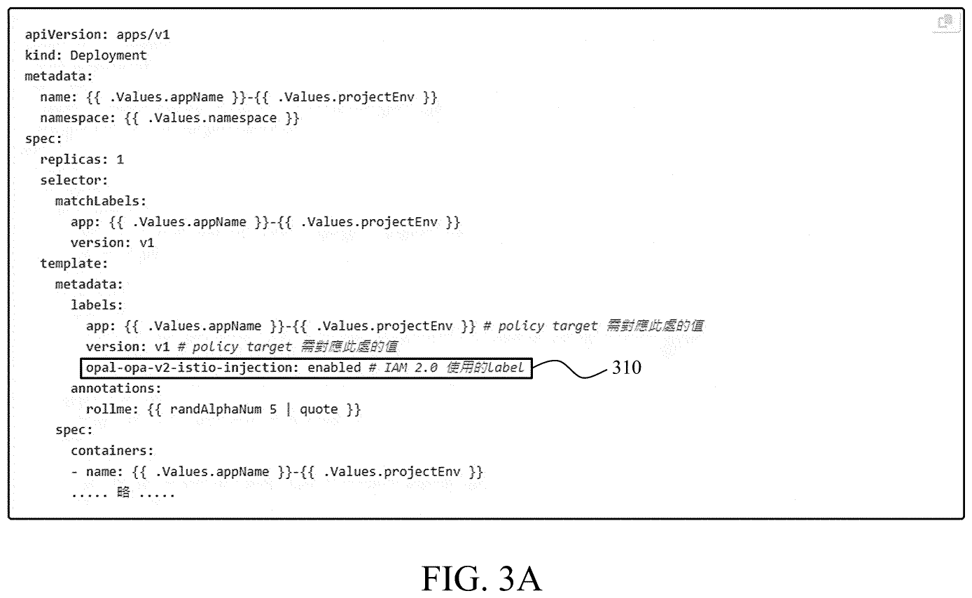

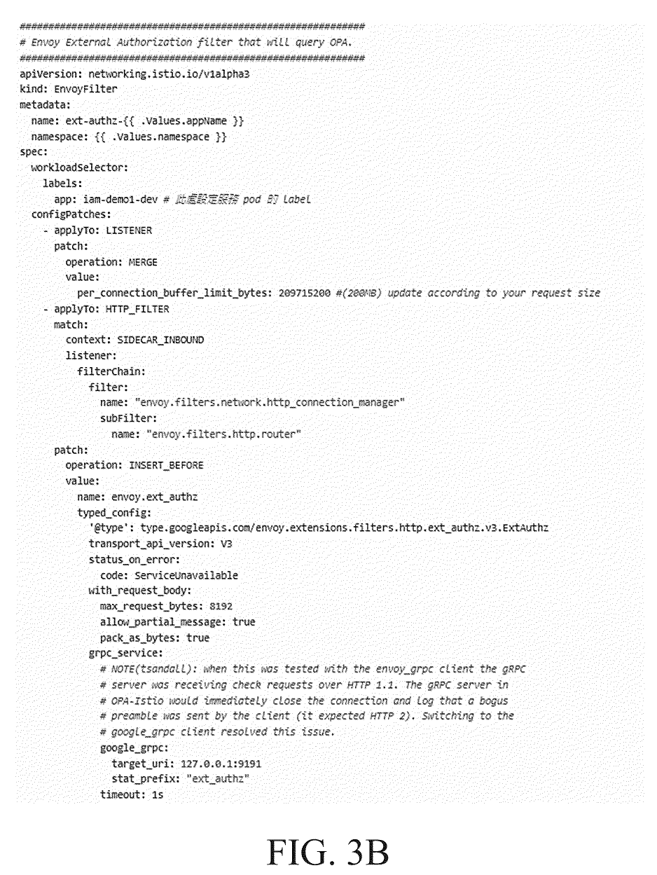

For example, in the Istio environment of Kubernetes, developers only need to add a label to the Deployment YAML they develop. As shown in FIG. 3A, developers only need to add a label 310 to the Deployment YAML. When the Pod carrying the container is started, the system for identity and access management may start the IAM policy agent that is attached in front of the service in sidecar mode.

FIG. 3B shows the program codes for setting up the IAM policy agent according to an embodiment of the present disclosure. The code in FIG. 3B is used to set up the request message to be forwarded to the IAM policy agent for verification.

In other words, no matter what programming language is used, the system for identity and access management may provide complete protection for the service by simply modifying one or two lines of code.

As described above, the method and system for identity and access management proposed in the present disclosure provide a unified standard identity and access management architecture (for example, the identity and access management architecture may include standard protocols of OAuth 2.0 and OIDC), which can not only significantly reduce the cost of development and maintenance, but also effectively reduce potential information security risks, thereby improving security. Furthermore, since the IAM policy agent is a decentralized device and stores the IAM policy information in a local cache, the IAM policy agent may still operate stably even when disconnected from the IAM policy center, further improving the reliability and stability of the system for identity and access management. In addition, the system for identity and access management proposed in the present disclosure supports a variety of environments, such as service meshes, application program interface managements, and monolithic services. Regardless of the environment, the system for identity and access management proposed in the present disclosure may operate efficiently and meet the needs of different application scenarios.

The embodiments described herein, including systems, methods/processes, and/or apparatuses, may be implemented using well known computers, such as the electronic device 400 shown in FIG. 4. The electronic device 400 is described as follows, for purposes of illustration.

Referring to FIG. 4, an exemplary operating environment for implementing embodiments of the present disclosure is shown and generally known as an electronic device 400. The electronic device 400 is merely an example of a suitable computing environment and is not intended to limit the scope of use or functionality of the disclosure. Neither should the electronic device 400 be interpreted as having any dependency or requirement relating to any one or combination of components illustrated.

The disclosure may be realized by means of the computer code or machine-use-able instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 4, the electronic device 400 may include a bus 410 that is directly or indirectly coupled to the following devices: one or more memories 412, one or more processors 414, one or more display components 416, one or more input/output (I/O) ports 418, one or more input/output components 420, and an illustrative power supply 422. The bus 410 may represent one or more kinds of buses (such as an address bus, data bus, or any combination thereof). Although the various blocks of FIG. 4 are shown with lines for the sake of clarity, and in reality, the boundaries of the various components are not specific. For example, the display component such as a display device may be considered an I/O component and the processor may include a memory.

The electronic device 400 typically includes a variety of computer-readable media. The computer-readable media can be any available media that can be accessed by electronic device 400 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 400. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 412 may include computer-storage media in the form of volatile and/or nonvolatile memory. The memory may be removable, non-removable, or a combination thereof. Exemplary hardware devices include solid-state memory, hard drives, optical-disc drives, etc. The electronic device 400 includes one or more processors that read data from various entities such as the memory 412 or the I/O components 420. The display com-ponent(s) 416 present data indications to a user or to another device. Exemplary presentation components include a display device, speaker, printing component, vibrating component, etc.

The I/O ports 418 allow the electronic device 400 to be logically coupled to other devices including the I/O components 420, some of which may be embedded. Illustrative components include a microphone, joystick, game pad, satellite dish, scanner, printer, wireless device, etc. The I/O components 420 may provide a natural user interface (NUI) that processes gestures, voice, or other physiological inputs generated by a user. For example, inputs may be transmitted to an appropriate network element for further processing. The electronic device 400 may be equipped with depth cameras, such as stereoscopic camera systems, infrared camera systems, RGB camera systems, or any combination thereof, to detect and identify objects. In addition, the electronic device 400 may be equipped with sensors (e.g., radar, lidar) to periodically sense the surrounding environment within a sensing range and generate sensor information representing the relationship between the electronic device 400 and the surrounding environment. Furthermore, the electronic device 400 may be equipped with accelerometers or gyroscopes that enable detection of motion. The output of the accelerometers or gyroscopes may be provided to the electronic device 400 for display.

Furthermore, the processor 414 in the electronic device 400 can execute the program code in the memory 412 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims to present elements of the various steps in a sample order and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded with the broadest interpretation so as to encompass all such modifications and similar arrangements.

What is claimed is:

1. A method for identity and access management, comprising:
receiving, by an identity and access management (IAM) policy center, IAM policy information, wherein the IAM policy information includes user account information, services that a user is allowed to access, and application programming interfaces that the user is allowed to access;
receiving, by an IAM policy agent, the IAM policy information transmitted by the IAM policy center;
verifying, by the IAM policy agent, whether a token is valid based on the IAM policy information when receiving a request message including the token corresponding to a first user transmitted by a front-end browser; and
allowing, by the IAM policy agent, the first user to access a first service that the first user is allowed to access when the token is valid.

2. The method for identity and access management as claimed in claim 1, further comprising:
denying, by the IAM policy agent, the first user access to the first service that the first user is allowed to access when the token is invalid.

3. The method for identity and access management as claimed in claim 1, wherein after the IAM policy center receives the IAM policy information, the method further comprises:
transmitting, by the IAM policy center, the IAM policy information to an identity provider;
receiving, by the identity provider, first account information of the first user input by the first user through the front-end browser;
generating, by the identity provider, the token according to the IAM policy information and the first account information of the first user; and
transmitting, by the identity provider, the token to the front-end browser so that the front-end browser generates the request message.

4. The method for identity and access management as claimed in claim 1, wherein the first service is in a service mash.

5. The method for identity and access management as claimed in claim 4, wherein the IAM policy agent is in the service mash.

6. The method for identity and access management as claimed in claim 1, wherein the request message is transmitted to the IAM policy agent through an application programming interface management (APIM).

7. The method for identity and access management as claimed in claim 6, wherein when the token is valid, the IAM policy agent allows the first user to access the first service that the first user is allowed to access through the APIM.

8. The method for identity and access management as claimed in claim 1, wherein after the IAM policy agent receives the IAM policy information, the IAM policy agent stores the IAM policy information in a cache.

9. The method for identity and access management as claimed in claim 1, wherein the token is in a JWT format.

10. The method for identity and access management as claimed in claim 1, wherein when the token is invalid, the IAM policy agent returns an HTTP status code 401 or an HTTP status code 403 to the front-end browser.

11. A system for identity and access management, comprising:
a first electronic device, configured to implement an identity and access management (IAM) policy center, wherein the IAM policy center executes:
receiving IAM policy information, wherein the IAM policy information includes user account information, services that a user is allowed to access, and application programming interfaces that the user is allowed to access; and
a second electronic device, configured to implement an IAM policy agent, wherein the IAM policy agent executes:
receiving the IAM policy information transmitted by the IAM policy center;
verifying whether a token is valid based on the IAM policy information when receiving a request message including the token corresponding to a first user transmitted by a front-end browser; and
allowing the first user to access a first service that the first user is allowed to access when the token is valid.

12. The system for identity and access management as claimed in claim 11, wherein the IAM policy agent denies the first user access to the first service that the first user is allowed to access when the token is invalid.

13. The system for identity and access management as claimed in claim 1, further comprising:
a third electronic device, configured to implement an identity provider;
wherein after the IAM policy center receives the IAM policy information, the IAM policy center transmits the IAM policy information to the identity provider;
the identity provider receives first account information of the first user input by the first user through the front-end browser;
the identity provider generates the token according to the IAM policy information and the first account information of the first user; and
the identity provider transmits the token to the front-end browser so that the front-end browser generates the request message.

14. The system for identity and access management as claimed in claim 11, wherein the processor further executes the following tasks:
wherein the first service is in a service mash.

15. The system for identity and access management as claimed in claim 14, wherein the IAM policy agent is in the service mash.

16. The system for identity and access management as claimed in claim 11, wherein the request message is transmitted to the IAM policy agent through an application programming interface management (APIM).

17. The system for identity and access management as claimed in claim 16, wherein when the token is valid, the IAM policy agent allows the first user to access the first service that the first user is allowed to access through the APIM.

18. The system for identity and access management as claimed in claim 11, wherein after the IAM policy agent receives the IAM policy information, the IAM policy agent stores the IAM policy information in a cache.

19. The system for identity and access management as claimed in claim 11, wherein the token is in a JWT format.

20. The system for identity and access management as claimed in claim 11, wherein when the token is invalid, the IAM policy agent returns an HTTP status code 401 or an HTTP status code 403 to the front-end browser.
